(19) United States
(12) Patent Application Publication
(10) Pub. No.: US 2016/0131808 A1
(43) Pub. Date: May 12, 2016

(54) AN OPTICAL DEVICE CAPABLE OF PROVIDING A STRUCTURAL COLOR, AND A CORRESPONDING METHOD OF MANUFACTURING SUCH A DEVICE

(71) Applicants: NIL TECHNOLOGY APS, Lyngby (DK); DANMARKS TEKNISKE UNIVERSITET, Lyngby (DK)

(72) Inventors: Anders KRISTENSEN, Frederiksberg C (DK); Emil HØJLUND-NIELSEN, Copenhagen Ø (DK); Niels Asger MORTENSEN, Kgs. Lyngby (DK); Jesper NØRREGAARD, Rødovre (DK)

(21) Appl. No.: 14/895,737

(22) PCT Filed: Jun. 4, 2014
(86) PCT No.: PCT/DK2014/050163

§ 371 Date: Dec. 3, 2015

(30) Foreign Application Priority Data
Jun. 4, 2013 (EP) 13170492.6

(51) Int. Cl. G02B 5/26; B29C 33/38; B29D 11/00; B29C 45/37; G02B 1/00; G02B 5/20

(52) U.S. Cl. CPC G02B 5/26; G02B 1/002; G02B 5/207; B29D 11/0074; B29C 45/37; B29C 33/3842; G02B 2207/101; B29K 2033/12

(57) ABSTRACT

The present invention relates to an optical device having a nano-structured surface capable of providing a structural color to a normal human viewer, the device made being manufactured in one single material. A plurality of nano-structured protrusions (5) is further arranged with a first periodicity (P1) in a first direction and a second periodicity (P2) in a second direction, the first and second periodicity being chosen so that the optical reflection is dominated by specular reflection. The nano-structured protrusions are optionally arranged with a relative spatial randomness (SR) with respect to the average surface positions. The position, size, and randomness of the protrusions are arranged so as to provide, at least up to a maximum angle of incidence (A_in) with respect to a normal to the surface, an angle-independent substantially homogeneous structural color perception for a normal human viewer, at least up to a maximum observation angle (A_obs) with respect to a normal to the surface.

### FIELD OF THE INVENTION

The present invention relates to an optical device capable of providing a structural color by a nano-structured surface, and a corresponding method of manufacturing such a device, e.g. in thermo-polymer.

### BACKGROUND OF THE INVENTION

The color of an object is the result of a complex interaction of the light incident on the object, the optical characteristics of the object, and human perception. Cf. for example Harold, R. W. (2001). An introduction to appearance analysis. Graphic Arts Technical Foundation, (No. 84):1-7.1. Given that manufactured products are meant to fulfill an intended purpose, their colors is one of their most important attributes. Today in many products, especially plastic products, the base color is given by bulk properties. Added surface decoration provides additional color effects, for example logos, text decoration or line art. This method provides cost effective color effects. However, the addition of decoration also makes recycling difficult, because the powerful pigments used for the thin decoration layers tend to pollute the base color of the bulk material in the recycling state. In the case of plastic products, only a small portion of an alien pigment added to the material in the melting process will change the bulk color.

Generally, colors of a given solid object can essential be made either by inherent coloring by scattering and chemical absorption (pigmentation) in the bulk of the object, or by reflection from the surface of the object, where for example the surface structure reflects certain colors by diffraction. Structural colors are such a special kind of optical phenomenon, where the structural shape on a surface determines the reflected spectrum of light. In nature, many examples of so-called structural colors are known, a well-known example being the wings of butterflies, e.g. the Morpho butterfly reflecting omnidirectional blue light due to a multilayer topography.

Examples of structural colors in nature are an inspiration for designing and manufacturing products with exterior surfaces of products having such properties.

Mohammad Harun-Ur-Rashid et al. recently published an article named Angle-Independent Structural Color in Colloidal Amorphous Arrays in ChemPhysChem 2010, 11, 579-583, where amorphous particle arrays consisting of two different submicron-sized mono-dispersed spherical silica particles are applied to obtain structural colored materials without angle dependence, which is similar to an amorphous array of b-keratin particles in avian feather barbs. The amorphous arrays obtained reveal angle-independent matte structural, the color depending on the weight ratio of the two differently sized silica particles. A pseudo band gap can be observed from the measurement of the transmission spectra of these samples. The peak positions of the pseudo band gap are virtually constant over incident angles between 0 degrees and 40 degrees. The silica particles were deposited on a glass substrate. However, this way of manufacturing structural colors on products is not very cost-effective because of the required additional processing of the product surface with silica particles. Moreover, products that require an opportunity to tilt or even rotate around an arbitrary axis during use may be problematic as the degree of attachment of the structured surface to the substrate is unknown. Most products with visible colors are exposed to some degree of wear from the ambient surroundings and must accordingly be quite robust during use, which may not be the case for such layers of silica particles.

US patent application 2009/0284696 (to Samsung Electronics Co) discloses a photonic crystal type color filter and reflective liquid crystal display (LCD) device having the same. The color filter includes a substrate, and photonic crystal disposed on the substrate having a two-dimensional grating structure thereupon. Thus, more complex manufacturing results due to the additional step of adding a photonic crystal.

Recently, Mihara M et al. in “Development and fundamental Experiments of Rubber Structural Color Sheet with Multi Grating Patterns”, Advanced Intelligent Mechatronics (AIM), 2012 IEEE/ASME International Conference on IEEE, 11 Jul. 2012, pp 1099-1104, disclosed a way of preparing rubber grating with multi pattern structures made from silicone rubber in molding process. The application as an optical strain sensor was also demonstrated. The structural color is based on diffraction of light in the pattern structures which may make the resulting color, e.g. blue or green, of the rubber grating too sensitive on the entry angle of the incoming light and the viewing angle of the viewer.

Hence, an improved optical device with structural colors would be advantageous, and in particular a more efficient and/or reliable optical device would be advantageous.

### OBJECT OF THE INVENTION

It is a further object of the present invention to provide an alternative to the prior art.

In particular, it may be seen as an object of the present invention to provide an optical device that solves the above mentioned problems of the prior art with robustness and/or cost-effectiveness of manufacturing.

### SUMMARY OF THE INVENTION

Thus, the above described object and several other objects are intended to be obtained in a first aspect of the invention by providing an optical device having a nano-structured surface capable of providing a structural color to a normal human viewer, the device made being manufactured in one material, the device comprising:
a bulk portion of device,
a surface portion of the device; both the bulk portion and the surface portion being manufactured in one and the same material, and
a plurality of nano-structured protrusions being part of the surface portion of the device, the nano-structured protrusions having an average height level (h) above an interface between the surface portion and the bulk portion, the nano-structured protrusions having substantially vertical sidewalls with respect to the said interface between the surface portion and the bulk portion, the nano-structured protrusions defining a filling factor (FF) being the ratio of the area of nano-structured protrusions relative to the total surface area,
   wherein the plurality of nano-structured protrusions is further arranged with a first periodicity (P1) in a first direction and a second periodicity (P2) in a second direction, the first and second periodicity being chosen so that the optical reflection is dominated by specular reflection at least up to a maximum angle of incidence with respect to a normal to the surface, both the first and the second periodicity (P1, P2) being below approximately 300 nm, preferably 250 nm, and larger than 100 nm, preferably 150 nm,
   wherein the height level (h) of the protrusions, the first and second periodicity (P1, P2) of the protrusions, and the filling factor (FF) of the protrusions are chosen so as to provide, at least up to said maximum angle of incidence (A_in) with respect to a normal to the surface, an angle-independent substantially homogeneous structural color perception for a normal human viewer, at least up to a maximum observation angle (A_obs) with respect to a normal to the surface.

The invention is particularly, but not exclusively, advantageous for obtaining an optical device capable of providing a structural color to a viewer over a relative broad range of observation angles in cost-effective manner, in particular because of the utilization of specular reflection. The nano-structure resulting in the structural color is also generally quite robust as the nano-structure is manufactured in the same material as the bulk of the device.

The various parameters of the optical device made in a specific material i.e. the height level (h) of the protrusions, the first and second periodicity (P1, P2) of the protrusions, optionally the relative spatial randomness (SR) of the protrusions, and the filling factor (FF) of the protrusions are simultaneous chosen, e.g. by appropriate modelling, to provide a desired structural color and thereby color appearance of a given product. The optical device according to the invention may be positioned, forming part of, being an integral part of, or constituting the product itself.

In the context of the present invention, by ‘nano-structured’ it is understood that the surface has a surface structure where characteristic lengths and dimensions are on the scale of nano-meters (i.e. 10⁻⁹ m), such as tens of nanometres or/and hundreds of nanometres. Alternatively, the surface nano-structure may be said to have characteristic lengths and dimensions being below the micrometer range (10⁻⁶ m, 1 μm) also called the sub-micrometer domain.

Structural colors are a kind of optical phenomenon, where the structural shape on a surface determines the reflected spectrum of light, which is quantitatively different from coloring of objects by e.g. pigmentation of the bulk material. The visible spectrum is the portion of the electromagnetic spectrum that is visible to (can be detected by) the normal human eye, typically, wavelengths ranging from 380 nm to 750 nm. The appearance of a color to a normal human viewer depends also not only on the wavelengths received by the retina, but also on the amount of energy in the received light. Hence, the eye's varying response to the same amount of energy at different wavelengths can be represented by luminosity curves for the human, as it is well-known by the skilled person in optics and colors, cf. also Harold (2001) cited above, which is hereby incorporated by reference in its entity. Thus, this should also be taken into account when designing an optical device according to the present invention. Notice that the eye's response can technically be well defined, e.g. by the CIE standard discussed below.

The mechanisms of structural colors may be categorized into thin-film interference, multilayer interference, diffraction-grating optical effects, and photonic crystal effects. Two examples of structural color are silicon nanowires on oxide thin-film creating color specific resonant scattering, and the Morpho butterfly reflecting omnidirectional blue light due to a multilayer topography. Artificial multilayer topographies like these require substantial fabrication.

The present invention is related to the structural color appearances from single-material one-layer surface textures, which may be better up-scalable compared to typical previous approaches for structural coloration. The reflectivity mode devices of the present invention allow for a number of applications, where surface decoration provides color effects, for example logos, text decoration, or line art.

The present invention provides an engineering method to specify a physical surface grating texture that will yield a desired novel angle-independent structural color, quantified by color measurements.

The influence of specular and diffusive reflections on color perception under different light conditions has been discussed for a long time. The present invention focus on specular color effects. Conventionally, in color analysis, the specular part is often subtracted to give a more accurate description of color. However, in the case where the specular reflection provides a constant distinct output spectrum for a wide range of angles, the manifestation can be a homogeneous color perception, if the illumination instead contains a diffusive component.

Thus, the present invention in particular uses the effect of specular reflection for various applications. It should be noted that diffraction as such is not as useful for many applications due to the angle dependency, and the high dependency on the light source. Thus, in order to obtain a specific color with diffraction one must have a certain unidirectional light source at a specific angle relative to the object, and the observer at a specific angle relative to the object. Thus, for example in FIG. 7A discussed below, the 500 nm periodicity case e) will show a diffraction color dependent on this angle. This is not acceptable in many commercial practical applications.

It is further to be understood that the structural color perception to a normal human is homogenous in the sense that a relatively narrow band of wavelengths is reflected, and may be perceived e.g. as a single color by a human viewer. Thus, the structural color is insensitive to angle change (with respect to a normal of the surface), e.g. that the variation up to certain maximum angle is so little or insignificant for human viewer. Appropriate acceptable band of variants can be defined if needed. In some variants, a plurality of colors as seen by a human viewer may be reflected.

It is to be understood that the optical device typically provides a complete 360 degree uniform azimuthal angle structure color, but for some variants this could be only for some azimuthal angle ranges.

Advantageously, the plurality of nano-structured protrusions may be additionally arranged with a relative spatial randomness (SR) with respect to the average surface positions, the spatial randomness varying both with respect to the distance (d) and the direction (A) of an average surface position of a protrusion, so that the relative spatial randomness (SR) of the protrusions is chosen so as to provide, at least up to said maximum angle of incidence (A_in) with respect to a normal to the surface, an angle-independent substantially homogeneous structural color perception for a normal human viewer, at least up to a maximum observation angle (A_obs) with respect to a normal to the surface.

The inventors have quite surprisingly demonstrated that the spatial randomness of the protrusions can be used to obtain the broad angle of homogenous structural color as will be explained in more detail below. In short, the non-periodic perturbation contributes to the broad angle independence of the structural color. This is because a fraction of the specular reflection is turned into diffusive reflection in a cone centered around the specular reflection. It should be mentioned that this spatial randomness may be intentionally implemented into the manufacturing of the optical device according to the invention and is not to be confused with the inherent randomness due to manufacturing tolerances and deviations, though the latter also contributes to the desirable effect. The spatial randomness of the protrusions according to the present invention is typical larger than inherent randomness from manufacturing, and hence it is possible to distinguish between the two sources of randomness.

Beneficially, the nano-structured protrusions have a spatial randomness (SR) with respect to the average surface positions, the spatial randomness varying both with respect to the distance (d) and direction (A) of an average surface position of a protrusion, of at least 5%, preferably at least 10%, more preferably at least 15%.

The bulk and the surface portion of the optical device are manufactured in one and the same material, e.g. polymer, and may typically be manufactured in one and same process, too, for example an injection moulding process where both the bulk and surface portion are molded together for efficient production. However, they may also be manufactured in two separate processes, e.g. in an injection molding process with a subsequent surface treatment process step if required.

A characteristic of the present invention is that substantially vertical sidewalls of the protrusions are provided in order to ensure maximal reflection of the optical device. The inventors have conducted numerous series of different types of optical stimulations and experiments in order to confirm that a sharp transition in refractive index gives optimum reflection as the basis for a structural color perception.

From rigorous coupled-wave analysis (RCWA) simulations and corresponding reflection measurements, it is found that any anomalies for dielectric one-layer one-material optical gratings are surface phenomena, independent of the bulk geometrical properties. Based on this, it is found, that the upper fundamental limit of light-matter interaction for e.g. injection-molding compatible structures is given by the corresponding dielectric interface, where the largest difference in refractive index occurs and thus the largest reflection of energy. This is true for all values of the bulk refractive index larger than that of the surrounding medium (air).

In particular, a series of thin film optical stimulations and experiments give insight into the dynamics as the number of layers is varied for linear graded surface structures, representing one-material injection-molding compatible surface structures with an increasing effective refractive index towards bulk. The reflectance for two layers is calculated, and likewise the corresponding curve for three layers is calculated. As the number of layers is increased, any interference between the layers is damped, essentially resulting in a spectrum of low reflectance. This effect is often used to create anti-reflective surfaces, such as “Black Silicon” surfaces, and explains why surfaces graded with structures tend to have a low reflectivity. Thus, the protrusions on the bulk portion of the device can be said to have the character of single layer of protrusions to maximize reflection-induced color effects.

It may be worth mentioned that the optical device according to the present invention has some resembles to a photonic crystal, but the grating-like structure of the present invention is nevertheless different. This may be illustrated by a quote from one of the founding fathers in the area of the photonic crystals:

“The most important consequence of a symmetry-breaking background [for optical gratings] is that the guided modes can no longer be classified as even or odd. Thus, there is no longer any band gap in the guided modes, and the photonic crystal properties of the slab are ostensibly lost. If the guided modes are sufficiently localized within the slab, however, so that the background is only a small perturbation, the wave functions may still be approximated as even or odd and some effects of the band gap will persist.”
Johnson, S. G., Fan, S., Villeneuve, P. R., and Joannopoulos, J. D. (1999). Guided modes in photonic crystal slabs. Physical review B, 60(8):5751-5758. 18.

Thus, the alternating structure of refractive index levels in photonic crystals is not found in the present invention.

It should be mentioned that the optical device works substantially by specular reflection which is—per definition—quite different from diffusive reflection. In specular reflection, the incident light beam is reflected in mirror-like way where the reflected light beam is reflection predominately in one direction. This is fundamentally different from diffusive reflection where the light is reflected in many directions due to the inherent (bulk) scattering of light within the material. The human perception of the color and three-dimensional shape of a given object stems from interpretation of visual stimuli in the visual cortex of the human brain. Therefore, the visual appearance of most products is based on the combination between an often weak specular reflection and typically a more dominant diffusive reflection, which is in contrast to the optical device described here mostly based on specular reflection.

It should further be noted that the angle independence of the structural color means that the color is substantially unchanged at least for normal human viewer. The concept of color perception may appropriately be measured by for example the Judd Vos correction to the CIE standard, cf. Vos, J. J. (1978). Colorimetric and photometric properties of a 2-deg fundamental observer. Color Research and Application, 3:125-128. 42. For suitable illumination of an optical device to be measured, various illumination sources such as the D65 standard sources can be used. The concept and practical measurements of color perception is known to the skilled person in optics.

This optical device according to present invention is an inherently passive device i.e. there is no energy stored in the device and the provided mostly specular reflection is provided by the light interaction with the surface itself.

In the context of the present invention, it should be mentioned that the term “protrusion” can be used in same technical meaning as “pillars”, “bulks”, etc. or similar as the skilled person would understand once the general principle and teaching of the present invention is comprehended.

In the context of the present invention, it should also be mentioned that the present invention may be implemented by the technical equivalent concept of manufacturing an optical device comprising holes, cavities, indents, indentation, recess or similar on the surface. In some sense, the filling factor (FF) may be used to operationally define whether the surface structure comprises protrusions or cavities. In short, this is more a matter of formal definition and wording than technical effect, as the skilled person working with topography and nanostructures would understand once the general principle and teaching of the present invention is understood.

The possible applications of the present invention are numerous. A non-exhaustive list of non-limiting examples includes:
decorative surfaces in various products incl. packaging (in particular single-time use), cars, toys, visible parts of electronics, etc.
mirror surfaces for an active light mirrors
High resolution optical labelling of products for preventing e.g. unlicensed copying
labelling or marking of medical instruments or implants where the labelling can be made of the bulk material i.e. one material manufacturing being important

The optical device may be integrated into a larger product, where the large product may be manufactured in one or more materials being different from the material in which the optical is manufactured. They may also, in a special case, be manufactured in the same material, e.g. a polymer.

In some applications of the invention, the optical device being manufactured in one material may additionally have a thin surface coating capable of protecting the optical device, e.g. lacquer or similar. The thin surface coating should be optical transparent and the optical device may therefore be slightly modified in order to take into account the optical properties of the surface coating, e.g. refractive index and thickness, so as to provide an overall uniform structural color perception to a viewer also with the thin surface coating on top of the protrusions.

Beneficially, the specular reflection may be a substantially mirror-like reflection in which an incident light beam is primarily reflected into a single observational angle (A_obs) for all azimuthal angles. Furthermore, the optical device may have resulting optical properties causing the specular reflection, which can be described in an effective medium optical regime where thin film reflection dominates together with a resonance regime. The effective thin film comprises air (or surrounding medium), protrusions and the bulk of the device. Thus, it may be said that the specular reflection which can be described in different optical regimes, such as a resonance regime and an effective medium regime where thin film reflection dominates

Advantageously, the optical device may function as a non-diffractive grating for which the first and second periodicity is sufficiently small to ensure that zeroth order diffraction, m=0, is the dominant reflection. Hence, the zeroth order is conventionally within this field of optics not consider to be diffraction as such but can be described as specular reflection More specifically, the optical device may fulfil the inequality;

$$\frac{Λ}{λ} < \frac{1}{max ( {n}_{2} , {n}_{1} ) + {n}_{1} sin {θ}_{max}} ,$$

where Λ is the first (P1) and second (P2) periodicity of the first and the second directions, respectively, λ is the wavelength of the incident light in the visible range, typically defined as approximately 380-750 nm, n₂ is the refractive index of the material the optical device is made of, and n1 is the refractive index of the surrounding medium, such as atmospheric air having n₁ approximately equal to 1. The maximum angle, named θₘₐₓ in the above formula, is the maximum observation angle, A_obs, with respect to a normal of the surface for having specular reflection.

Typically, the optical device may have an angle-independent specular reflection for a maximum observation angle (A_obs) with respect to a normal to the surface for at least 45 degrees, preferably at least 60 degrees, more preferably at least 75 degrees for an angle of incident angle (A_in) of zero with respect to a normal to the surface. For many practical applications, this angle range may be sufficient to provide an acceptable uniform color perception for viewers.

Beneficially, the substantially vertical sidewalls with respect to the normal of said interface between the surface portion and the bulk portion may have a slope angle of maximum 2 degrees, preferably maximum 5 degrees, more preferably maximum 10 degrees, with the protrusions being slightly narrower at the top.

Advantageously, wherein the nano-structured protrusions may have an average height level (h) above an interface between the surface portion and the bulk portion in the interval from approximately 30-300 nm, preferably approximately 40-250 nm, more preferably approximately

50-200 nm.

In various embodiments, the material may be a semiconductor material, such as silicon, preferably the shape of the protrusions, as seen normal to the said interface, being of a quadratic, a pentagonal, a hexagonal, or higher order polygonal form.

In other embodiment, the material of the optical device may be a dielectric material, such as a polymer, preferably the filling factor (FF) being in the interval from 35-65%.

A non-exhaustive and non-limiting list of polymer suitable for being applied in the context of the present invention includes:

### PELD: PolyEthylen—Low Density

### PEHD: PolyEthylen—High Density

### PP: Polypropylene

PA: polyamide
TPE: Thermoplastic elastomers
ABS: Acrylonitrile butadiene styrene

### ASA: Acrylonitrile Styrene Acrylate

### PC: Polycarbonate

### PS: Polystyrene

### Silicone

PMMA: Poly(methyl methacrylate)

In yet another embodiment, the said material of the optical device may be metal or metal alloy.

In a second aspect, the invention relates to a method for manufacturing an optical device having a nano-structured surface capable of providing a structural color to the normal human eye, the method comprising:
providing a form comprising a corresponding master structure for the nano-structured surface capable of providing a structural color to the normal human eye,
performing a molding, casting or forming process with the form using a moldable material, and
obtaining the optical device, the device made being manufactured in said moldable material, the device comprising:
a bulk portion of device,
a surface portion of the device; both the bulk portion and the surface portion being manufactured in one and the same moldable material, and
a plurality of nano-structured protrusions being part of the surface portion of the device, the nano-structured protrusions having an average height level (h) above an interface between the surface portion and the bulk portion, the nano-structured protrusions having substantially vertical sidewalls with respect to the said interface between the surface portion and the bulk portion, the nano-structured protrusions defining a filling factor (FF) being the ratio of the area of nano-structured protrusions relative to the total surface area,
   wherein the plurality of nano-structured protrusions is further arranged with a first periodicity (P1) in a first direction and a second periodicity (P2) in a second direction, the first and second periodicity being chosen so that the optical reflection is dominated by specular reflection at least up to a maximum angle of incidence with respect to a normal to the surface, both the first and the second periodicity (P1, P2) being below approximately 300 nm, preferably 250 nm, and larger than 100 nm, preferably 150 nm, and
   wherein the height level (h) of the protrusions, the first and second periodicity (P1, P2) of the protrusions, the relative spatial randomness (SR) of the protrusions, and the filling factor (FF) of the protrusions are chosen so as to provide, at least up to said maximum angle of incidence (A_in) with respect to a normal to the surface, an angle-independent substantially homogeneous structural color perception for a normal human viewer, at least up to a maximum observation angle (A_obs) with respect to a normal to the surface.

Advantageously, the form may be an injection molding tool capable of performing injection molding. Some examples of injection molding include, but is not limited to:
In-mold decoration and in-mold lamination
Injection-compression molding
Low-pressure injection molding
Lamellar (microlayer) injection molding
Microinjection molding
Film insert molding
Blow molding

Preferably, the performing of a molding, casting or forming process may be an injection molding process, and the moldable material may comprise a thermoplastic. More advantageously the nano-structured protrusions have an average Aspect ratio being at least approximately 1:2, preferably at least approximately 1:1, more preferably at least approximately 2:1, so as so enable efficient injection molding of the protrusions.

In a second aspect, the present invention thus relates to a method of manufacturing an optical device according to the first aspect. Additionally, the present invention relates to a method of manufacturing an optical device according to the third aspect below i.e. with spatial randomness (SR) of the protrusions.

Thus, the plurality of nano-structured protrusions may be additionally arranged with a relative spatial randomness (SR) with respect to the average surface positions, the spatial randomness varying both with respect to the distance (d) and the direction (A) of an average surface position of a protrusion, so that the relative spatial randomness (SR) of the protrusions is chosen so as to provide, at least up to said maximum angle of incidence (A_in) with respect to a normal to the surface, an angle-independent substantially homogeneous structural color perception for a normal human viewer, at least up to a maximum observation angle (A_obs) with respect to a normal to the surface.

The inventors have quite surprisingly demonstrated that the spatial randomness of the protrusions can be used to obtain the broad angle of homogenous structural color as will be explained in more detail below. In short, the non-periodic perturbation contributes to the broad angle independence of the structural color.

In a third aspect, the invention relates to an optical device having a nano-structured surface capable of providing a structural color to a normal human viewer, the device made being manufactured in one material, the device comprising:
a bulk portion of device,
a surface portion of the device; both the bulk portion and the surface portion being manufactured in one and the same material, and
a plurality of nano-structured protrusions being part of the surface portion of the device, the nano-structured protrusions having an average height level (h) above an interface between the surface portion and the bulk portion, the nano-structured protrusions having substantially vertical sidewalls with respect to the said interface between the surface portion and the bulk portion, the nano-structured protrusions defining a filling factor (FF) being the ratio of the area of nano-structured protrusions relative to the total surface area,
   wherein the plurality of nano-structured protrusions is further arranged with a first periodicity (P1) in a first direction and a second periodicity (P2) in a second direction, the first and second periodicity being chosen so that the optical reflection is dominated by specular reflection at least up to a maximum angle of incidence with respect to a normal to the surface, both the first and the second periodicity (P1, P2) being below approximately 300 nm, preferably 250 nm, and larger than 100 nm, preferably 150 nm,
   wherein the plurality of nano-structured protrusions is additionally arranged with a relative spatial randomness (SR) with respect to the average surface positions, the spatial randomness varying both with respect to the distance (d) and the direction (A) of an average surface position of a protrusion, and
   wherein the height level (h) of the protrusions, the first and second periodicity (P1, P2) of the protrusions, the relative spatial randomness (SR) of the protrusions, and the filling factor (FF) of the protrusions are chosen so as to provide, at least up to said maximum angle of incidence (A_in) with respect to a normal to the surface, an angle-independent substantially homogeneous structural color perception for a normal human viewer, at least up to a maximum observation angle (A_obs) with respect to a normal to the surface.

Thus, the present invention according to the third aspect relates to an optical device, which is different from the invention according to the first aspect in that the protrusions are arranged with a spatial randomness with respect to their average positions. Thus, all other embodiments of the invention according to the first aspect may be combined with the invention according to the third aspect as it will be appreciated by a person skilled in the art.

The individual aspects of the present invention may each be combined with any of the other aspects. These and other aspects of the invention will be apparent from the following description with reference to the described embodiments.

### BRIEF DESCRIPTION OF THE FIGURES

The invention will now be described in more detail with regard to the accompanying figures. The figures show one way of implementing the present invention and is not to be construed as being limiting to other possible embodiments falling within the scope of the attached claim set.

FIG. 1 a) and b) is a side/top view and a perspective schematic view, respectively, of an optical device according to the present invention,

FIGS. 2-7 illustrates an embodiment of an optical device according to the present invention manufactured in silicon,

FIG. 2 is schematic series of steps in the manufacturing process of an optical device according to the invention,

FIG. 3 is a schematic illustration how spatial randomness is implemented in the optical device,

FIG. 4 shows SEM images of four different periodicity of the optical device according to the invention,

FIG. 5 shows measured specular reflection in two different plots,

FIG. 6 shows RCWA-simulated and measured silicon specular colors at different angles,

FIG. 7 shows simulated specular color maps together with a photograph of silicon wafer (below) corresponding to the 4 white squares in the color map above,

FIGS. 8-10 illustrate an embodiment of an optical device according to the present invention manufactured in polymer,

FIG. 8 schematically shows various cross-sectional views of surface structures considering for injection molding,

FIG. 9 is a graph showing reflection as a function of refractive index,

FIG. 10 is demonstration model of an optical device made in polymer according to the present invention having a blue structural color,

FIGS. 11-13 are a stimulated specular reflection color maps performed for an optical device according to the present invention manufactured in polymer, a material with refractive index, n, of 2, and metal (aluminium),

FIGS. 14A and 14B shows two photographs of an optical device according to the invention made in silicon and a corresponding polymer (PMMA), respectively, showing many colors like a color chart, and

FIG. 15 is a schematic flow chart representing an out-line of the method according to the invention.

### DETAILED DESCRIPTION OF AN EMBODIMENT

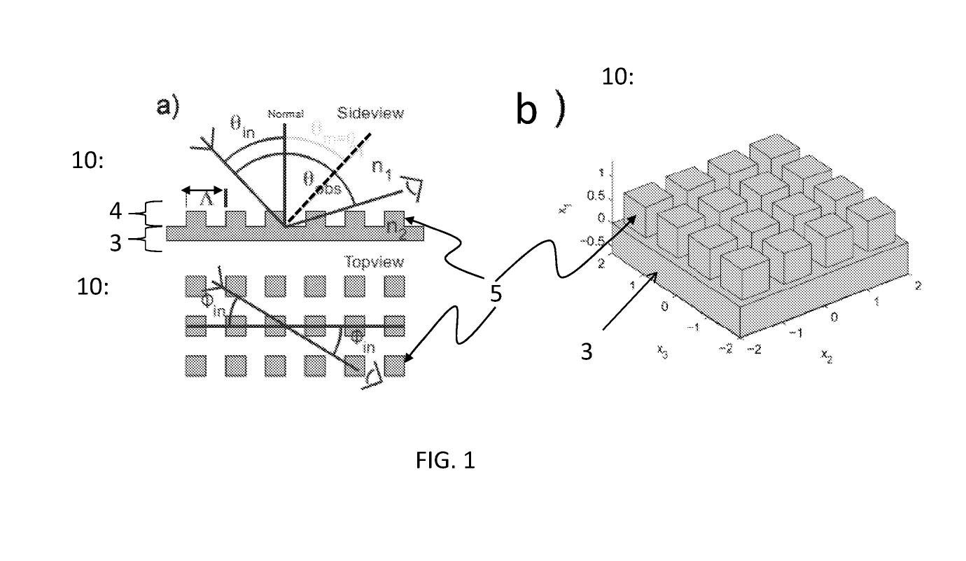

FIG. 1 a) and b) is a side/top view (side upper part, top view with only protrusions in the lower part) and perspective schematic view, respectively, of an optical device 10 according to the present invention having a nano-structured surface capable of providing a structural color to a normal human viewer. The device is manufactured in one material, e.g. polymer, metal or silicon, the device comprises a bulk portion 3 of the device, and a surface portion 4 of the device; both the bulk portion and the surface portion being manufactured in one and the same material, as seen in the FIG. 1 a) upper part. The interface between the bulk and surface portion may constitute the upper part of the bulk portion.

The surface portion 4 has a plurality (typically billions per cm²) of nano-structured protrusions 5 forming part of the surface portion 4 of the device 10. The nano-structured protrusions 5 have an average height level, h, above the interface between the surface portion 4 and the bulk portion 3. The nano-structured protrusions 5 having substantially vertical sidewalls with respect to the said interface between the surface portion and the bulk portion as seen in FIG. 1. The nano-structured protrusions define an overall, average filling factor, FF, being the ratio of the area of nano-structured protrusions relative to the total surface area. Alternatively, or equivalently the filling factor, FF, can be defined via the unit cell of the surface.

The plurality of nano-structured protrusions 5 is further arranged with a first periodicity P1 in a first direction and a second periodicity P2 in a second direction, schematically indicated in FIG. 1 a) upper top view with a period Λ between the protrusions 5. In this figure, the first and second direction can be orthogonal to each other, but other configurations are possible. The first and second periodicity is chosen so that the optical reflection is dominated by specular reflection, at least up to a maximum angle of incidence, named θᵢₙ in FIG. 1 but generally denoted A_in, with respect to a normal to the surface (also shown). The first and second periodicity is—for this embodiment—the same period, but generally they can be different.

For curved surfaces, the normal may be the local normal as it will understood by a person skilled in the art. Both the first and the second periodicity (P1, P2) is below approximately 300 nm, preferably 250 nm, and larger than 100 nm, preferably 150 nm, in order to yield non-diffractive specular reflection according to the invention.

It is worth mentioning that the specular reflection will generally be indifferent with respect to azimuthal incidence angle φᵢₙ, the latter angle being defined in FIG. 1 a) lower top view.

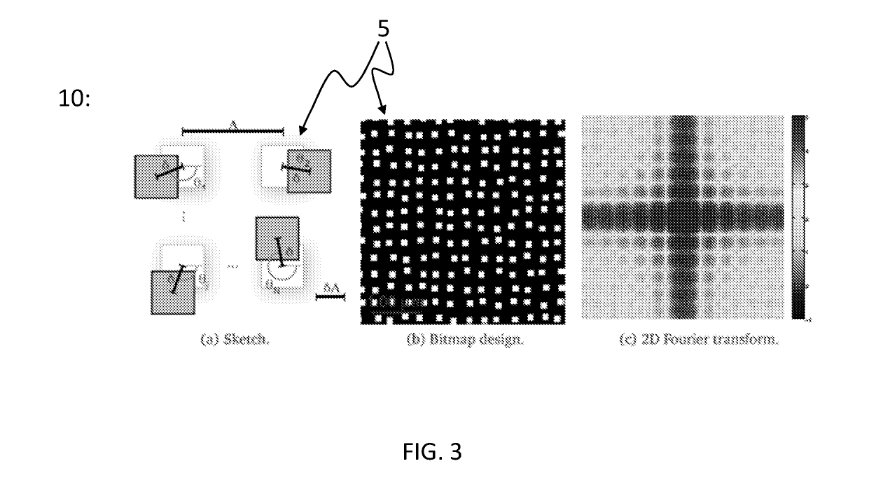

The plurality of nano-structured protrusions 5 is additionally arranged with a relative spatial randomness SR with respect to the average surface positions, the spatial randomness varying both with respect to the distance δᵢ and direction θᵢ of an average surface position of a protrusion, as explained in connection with FIG. 3 below.

The core of the invention is that the height level, h, of the protrusions, the first and second periodicity, P1 and P2, of the protrusions, the relative spatial randomness SR of the protrusions, and the filling factor FF of the protrusions 5 are all chosen so as to provide, at least up to said maximum angle of incidence A_in with respect to a normal to the surface, an angle-independent substantially homogeneous structural color perception for a normal human viewer, at least up to a maximum observation angle A_obs with respect to a normal to the surface.

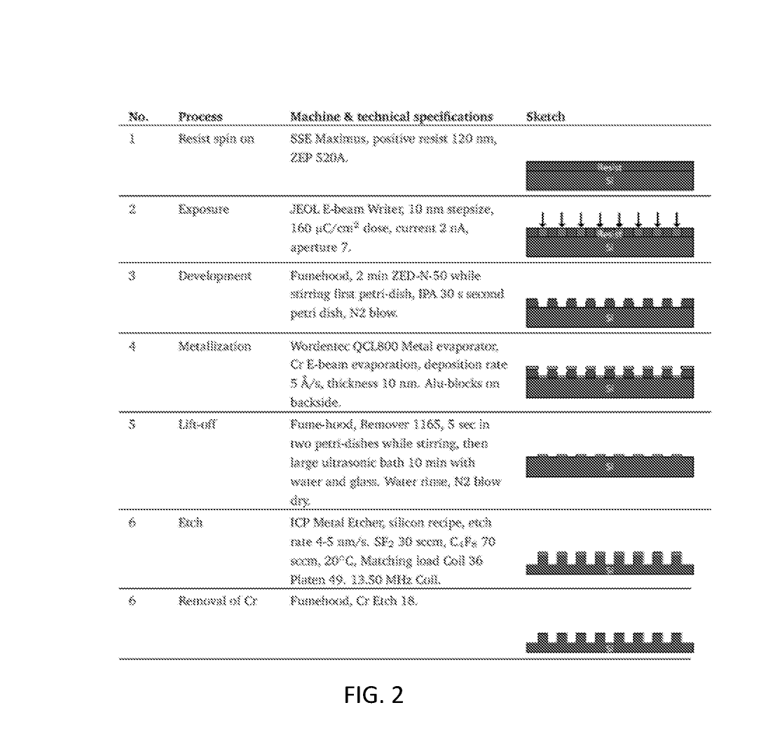

FIGS. 2-7 illustrates an embodiment of an optical device according to the present invention manufactured in silicon.

FIG. 2 is schematic series of steps in the manufacturing process of an optical device according to the invention. The fabrication process is shown along with the most relevant technical details. First the positive resist ZEP 520A is spin-coated on top of the two wafers with a thickness of 162 nm, measured by ellipsometry. Then two wafers are exposed using Electron Beam Lithography with different doses of 280 μC/cm² (Wafer 1) and 320 μC/cm² (Wafer 2) in order improve the yield of the process. The electrons in the beam have an energy of 100 keV. The beam step-size is 10 nm, which is the reason for the all dimensions being a multiple of the 10 nm step size. After the exposure, the positive resist is developed, which removes the resist where the holes are to be defined. Then an inductively coupled plasma etch is applied, with a high selectivity towards silicon compared to resist, using a cyclic Bosch process with alternating etch (SF6 and O2) and passivation (C4F8) phases, etching approximately 35 nm per cycle. The etch causes holes to be defined in the silicon and the two wafers are subject to different etching times in order to test different hole depths. Finally, the remaining resist is removed by using microwaves and oxygen plasma.

In the metallization step 4, the metal thickness is varied by individual process runs on five wafers using electron beam evaporation of a Cr crystal. It seems likely that these are tall spikes formed by deposited Cr metal accidentally covering the sidewalls of the resist. After lift-off 5, these “ears” will be standing upwards from the surface. The density of ear-defects is found to be independently on metal thickness and therefore these defects must be formed by the first nanometers of metal indicating that an alteration of the deposition rate in the beginning of the process may help to solve some of these issues. For all wafers processed at the same time, the number of ear-defects seems constant, indicating that ear-defects cannot just be avoided by using a dummy wafer first to stabilize the conditions in the vacuum chamber.

FIG. 3 is a schematic illustration how spatial randomness may be implemented in the optical device. Semi-periodic structures may be a route to angle independent structural colors in high dielectric materials. It is known that low group velocity band-edge modes can be scattered by introducing randomness in photonic crystals. Here we utilize the same principle. Deviation directions are randomly different from pillar to pillar described by the random angle _rand and the randomness parameter, with the deviation length 6 kept constant at each pillar as sketched in FIG. 3 (a), the spatial deviation being denoted d or δ, and the angular deviation being denoted A, or θᵢ, i being a running subscript for the protrusions as indicated. The E-Beam Writer machine JEOL-JBX9300FS at DTU Danchip does not contain a random generator feature and therefore different solutions and file formats, such as the Caltech Intermediate Form (CIF) or the Graphic Database System format (GDSII), are considered. Before any structure can be realized a number of at least five file conversions takes place leading to a high risk of conversion errors. On the other hand, any solution for random generation must also respect hardware limitations for example only 5 Gigabytes of random access memory. It is decided to use the rather flat GDSII stream format and then divide the random pattern into cells of 62.5 micrometer×62.5 micrometer, meaning that a given area is then defined by repeating the same cell. In practice, a side length of 62.5 micrometer is large enough to mimic infinite random patterns.

First a binary bitmap image file is generated which is loaded into the Computer-aided design program L-Edit 15.0. Then the L-Edit layout is exported into GDSII and converted further. An algorithm is developed which generates the binary file for random structures, as seen in FIG. 3 (b). A two dimensional Fourier transform of the 62.5 micrometer×62.5 micrometer area is seen in FIG. 3 (c). The MATLAB command fft2(M,512,512) is used and the Fourier components are plotted on an absolute logarithmically scale, meaning that the darkest frequencies in the center are 6 orders of magnitude stronger than light color frequencies. This clearly indicates than periodicity still dominates even though some noise is added but still leading to controlled scattering.

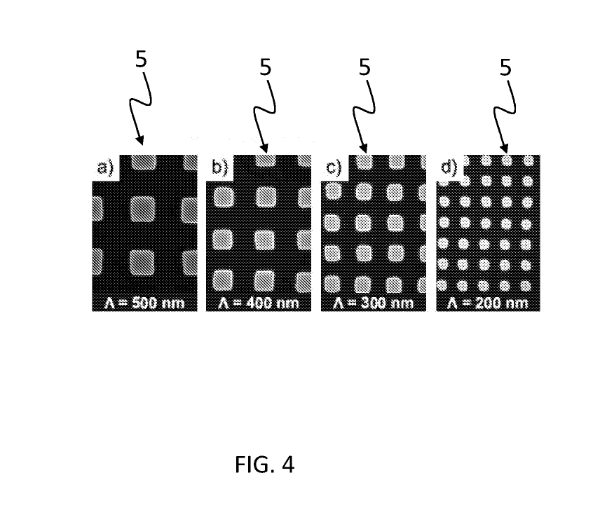

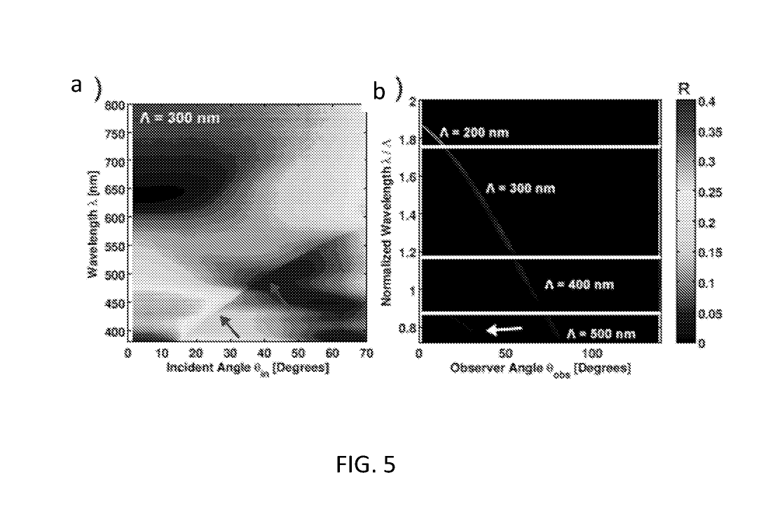

FIG. 4 shows SEM images of four different periodicity of the optical device according to the invention. The experimental work presented here is based on four samples, each of size of 1 cm×1 cm, of articial nano-structures or protrusions fabricated on a single wafer using electron beam lithography and dry etching as described in connection with FIG. 2. The patterns, characterized as diffraction gratings, consist of quadratic structures in a quadratic lattice with periods P1 and P2 of 500 nm, 400 nm, 300 nm, and 200 nm, P1 and P2 in this case being equal and orthogonal to each other. Scanning electron microscope (SEM) images of the four samples can be seen in FIG. 4 a-d, respectively. The radius of the corner rounding are similar for the four samples, and the overall structures appear more rounded as the period decreases. The heights of the structures are measured by atomic force microscopy (not shown) to be around 180 nm. The four samples have been implemented without spatial randomness. Thus, the invention may work with and without the spatial randomness SR.

For background, the reflection and transmission angular distribution of periodic structures are given by the well-known grating equation:

$$\begin{matrix}{n}_{1} sin {θ}_{m} - {n}_{1} sin {θ}_{in} = \frac{m λ}{Λ} , ( reflec . orders ) & ( 1 a ) \\ {n}_{2} sin {θ}_{m} - {n}_{1} sin {θ}_{in} = \frac{m λ}{Λ} , ( trans . orders ) & ( 1 b )\end{matrix}$$

where n₁ and n₂ are the refractive indices of the incident medium (air) and transmission medium (silicon) respectively, θᵢₙ is the incident angle of the light, and θₘ is the angle of the m'th order reflection, both with respect to the surface normal, see FIG. 1 a). The transition from a non-diffractive to a diffractive reflective grating occurs at the corresponding Rayleigh wavelength; λ_{R}(θᵢₙ)=Λ(sin θᵢₙ+1), where first order (m=1) emerges at glancing angle and the redistribution of energy results in an anomaly (rapid variation) in the specular reflection. In addition, a resonance type linked to leaky surface modes exists. Reflection measurements are performed for TE/TM (not shown), and unpolarized light, using a xenon lamp (HPX-2000), two rotational stages, and a spectrometer (Jaz, Ocean Optics). The broad spectrum white light from the Xenon lamp is coupled via a multi-mode fibre to illuminate the sample at an angle of incidence θᵢₙ. The reflected light is collected at an observer angle θ_{obs}, by the end of a multimode fiber, and led into the spectrometer. With the definitions in FIG. 1 a), specular reflection is measured by θ_{obs}=2θᵢₙ. The direct reflection (m=0) is also indicated by a dashed line The absolute reflection is calculated using a reference measurement before and after each measurement.

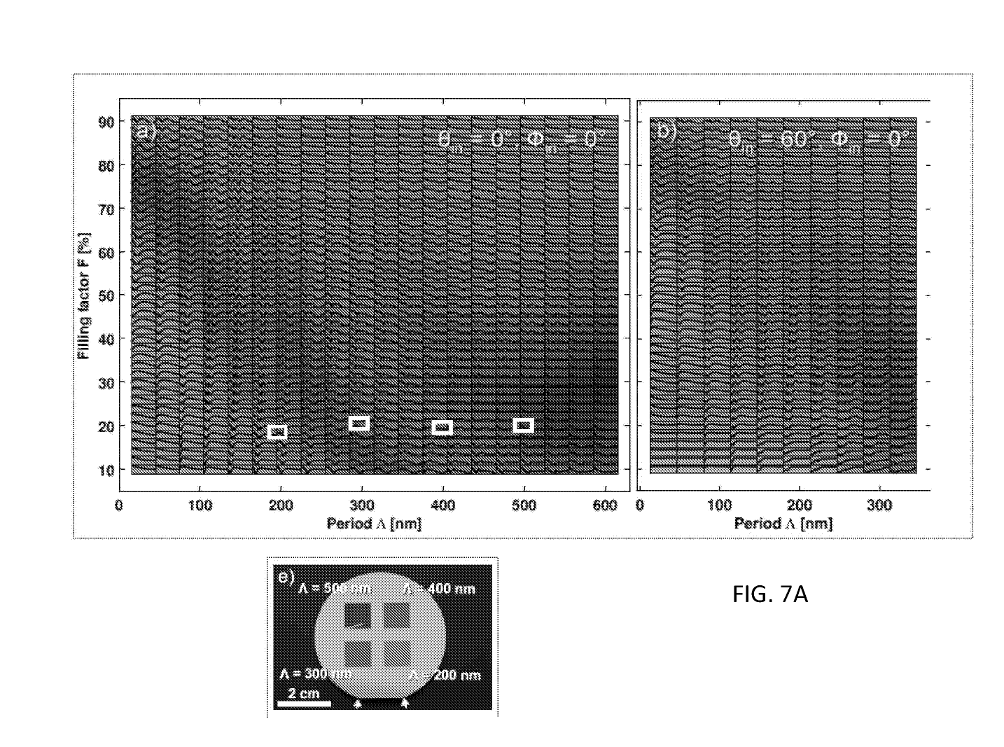

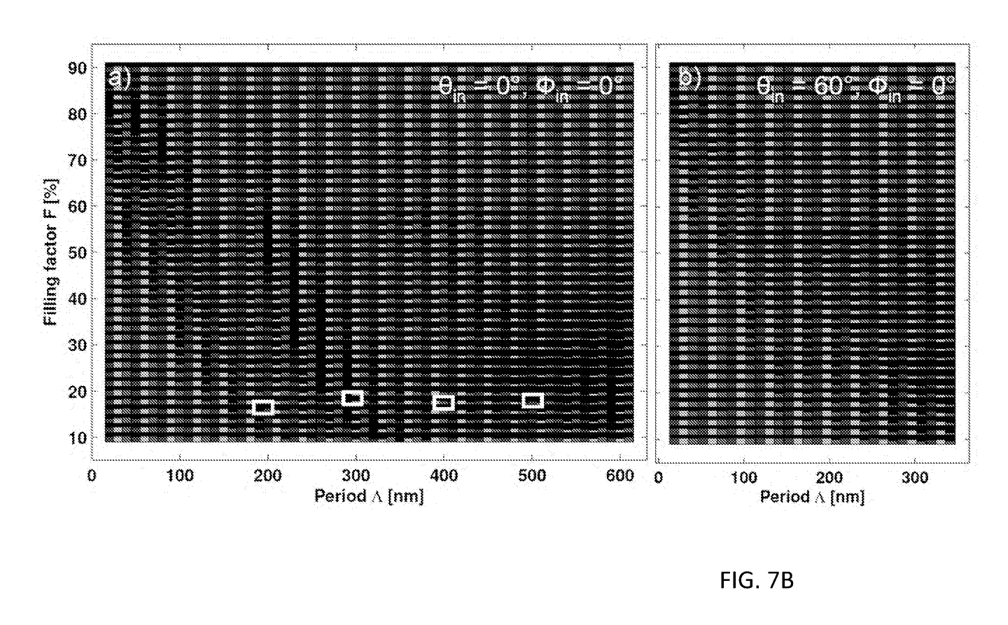

Regarding diffraction also described by Eqs. (1a) and (1b) above, it should be emphasized this does not occur in reflection mode until 64 degrees for 200-nm periodic structures in the visual spectrum (λ_{R}=380 nm). Therefore, the structural colors originating from a 200-nm periodic structures only exhibit minor angular dependence up to 60 degree incidence in all azimuthal directions, as for example seen in FIG. 7A, due to the suppression of diffraction and the substituted strong coupling of light to localized surface states

However, one may combine the colors according to the present invention with diffraction, by viewing a given grating sample under two incoherent light sources, such that the main specular reflectivity is observed using one source and a diffraction order is observed using the other source. As the diffraction order redirects light in the direction of the observer, the combination yields additive color mixing, in contrast to the specular absorptive colors. The implication is the marvel of color effects taking place when the specular color appearances are accompanied by diffraction effects pointing to the difficulty of unambiguously defining structural colors. However, for the present invention this difficulty is avoided by having the freedom to obtain color of the desired design by utilising specular reflection.

FIG. 5 shows measured specular reflection in two different plots, the measured specular reflection of the sample with a period of 300 nm can be seen as function of wavelength and angle of incidence, performed along a horizontal line in FIG. 5 a) (θᵢₙ=0 deg.).

FIG. 5. a): Measured specular reflection for the 300 nm period sample from 0% to 40% as function of incidence angle and wavelength. Arrows mark the Rayleigh line.

FIG. 5 b): Measured Reflection from 0% to 40% for a constant incidence angle of 70 deg. as function of observer angle and normalized wavelength of the four samples. Arrow marks second order. Resolution is 0.5 deg.

The normal incidence measurement shows a distinctive minimum at a wavelength of 640 nm, corresponding to a normalized frequency of Λ/λ=0.47 and a normalized height of h/Λ=0.58, which by simulation (not shown) is found to indicate a resonance anomaly behavior with strong coupling to a leaky surface wave. The relatively high reflection for short wavelengths (specular reflection is maximum in the lower left corner of the FIG. 5 a) plot for wavelengths around 400 nm and incident angle below 10 deg.) can be explained as a combination of a rapidly increasing refractive index of silicon for short wavelengths and the absence of anomalies for the particular parameters. Regarding angular dependence, the distinctive line of low reflection can be identified as the so-called “Rayleigh line”, meaning that diffraction in the visual spectrum does not occur until 15 deg. incident angle. Thereby, the measurement captures the transition from the non-diffractive regime of exclusive specular reflection at normal incidence to the diffraction regime for larger incidence angles, also supported by the tendency of low reflection for wavelengths shorter than the Rayleigh line due to the appearance of higher reflection orders. Besides measuring the specular reflection, one measurement for each sample is conducted, where the incidence angle is held constant at an angle of θᵢₙ=70 deg. along the horizontal direction, while the observer angle is varied. The measured TM reflection can be seen in FIG. 5, confirming that the angle distribution of the reflection is due to diffraction described by Eq. (1) above.

The color of an object is the result of a complex interaction between the light source S(λ) incident on the object, the reflection or transmission of the object R(λ) or T(λ), and the observer modeling the spectral sensitivity of human perception. In the CIE 1931 XYZ-model, colors can be defined on integral form:

$$[ \begin{matrix}X \\ Y \\ Z\end{matrix} ] ≡ {C}^{- 1} {\int }_{0}^{∞} S ( λ ) R ( λ ) [ \begin{matrix}{\overline{x}}_{obs} ( λ ) \\ {\overline{y}}_{obs} ( λ ) \\ {\overline{\overline{z}}}_{ obs} ( λ )\end{matrix} ] d λ , \qquad ( 2 )$$

with normalization: C≡∫₀^{∞}S(λ)y̅_{obs}(λ)dλ

The parameters (x_{obs}, y_{obs}, z_{obs}) describe the spectral sensitivity of the observer and roughly correspond to the sensitivity of the three cones (fovea centralis) of the human eye. In the context of the present invention, the notion of ‘a normal human viever’ is accordingly a technically well-defined term for person working with optics, in particular color engineering. Here, we use the 1978 Judd Vos correction of the CIE 1931 2 deg. observer and the ISO/CIE standard illuminant D65. In order to accurately present color values, a conversion between the device-independent CIE-XYZ model and device-dependent outputs on a display (voltages expressed in RGB) or paper (CMYK) is needed. Here we adopt the sRGB conversion for display. The grating scattering properties are studied by RCWA using a commercial solver (GD-Calc, KJ Innovation) for simulating the absolute values of reflection and transmission. Due to the large dispersion in silicon and the dependence on the exact structural dimensions, each point in the (θᵢₙ; φᵢₙ; λ) parameter space must be individually assessed for given structural dimensions.

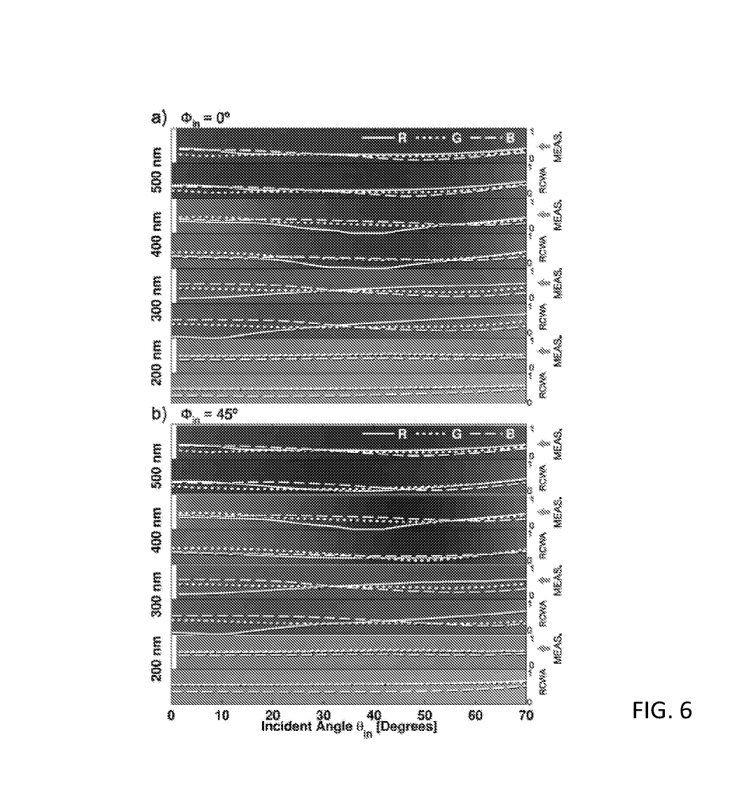

FIG. 6 shows RCWA-simulated and measured silicon specular colors at different angles, a) for μᵢₙ=0 deg. and b) μᵢₙ=45 deg. The calculated sRGB color values of the measurements and corresponding simulations are plotted and displayed as function of incident angle in FIG. 6 a) and b) for the horizontal and diagonal directions. In terms of color, the sample with a period of 300 nm appears blue due to a low reflection of red light around the earlier mentioned minimum at 640 nm, and high reflection around 400 nm. The shift to a brown/orange color at 30 deg. incidence is due to the appearance of first order diffraction cutting off the normal incidence features and the increase in Fresnel reflection for larger incidence angles. The main differences between the horizontal and diagonal reflection, leading to shifts in color, can be understood by the shorter projected effective period Λ′ seen by the diffracted light for the diagonal direction, ideally Λ/√2 for an incident angle of 90 deg. In general, the calculated colors in FIG. 6 are found by visual inspection of the different samples to resemble daylight color accurately. One may combine the colors portrayed here with the earlier measured diffraction results, by viewing a given grating sample under two incoherent light sources, such that the main specular reflection is observed using one source and a diffraction order is observed using the other source. As the diffraction order redirects light in the direction of the observer, the combination yields additive color mixing, in contrast to the specular subtractive color mixing. The implication, is the marvel of color effects taking place when the specular color appearances are accompanied by diffraction effects pointing to the difficulty of unambiguously defining structural colors.

Interestingly, it is found experimentally that the structural colors originating from 200 nm periodic structures only exhibit minor angular dependence up to at least 70 deg. incidence in all azimuthal directions. For the 200 nm period, diffraction described by Eq. (1) in the visual spectrum (λR=380 nm) does not occur until 64 deg., which provides the uniform color appearance seen in all photographs of FIG. 7 bottom. While the appearance of angle-dependent diffraction orders is determined exclusively by the period, normal incidence anomalies can be understood in terms of normalized frequency, height h, and filling factor FF due to scale invariance. This leads to a window of design where non-diffractive angle-independent colors may be provided by deliberately suppressing diffraction and instead couple to normal incidence anomalies. However, as the number of anomalies responsible for the colors decreases for lower frequencies, the possibilities of coloring are mainly given by the scaling between frequency and period, providing some restrictions to the concept.

FIG. 7A shows simulated specular color maps together with a photograph of silicon wafer (below) corresponding to the 4 white squares in the color map above. In particular, FIG. 7 e) illustrates the near normal incidence specular colors of the four samples. In FIG. 7 “a specular color map” is plotted for a structure height h of 180 nm. The map is constructed by simulating the reflection of squared two-dimensional silicon gratings converted into a color via Eq. (2). The normal incidence colors in FIG. 7 a) can be interpreted in the context of the three optical regimes for gratings. For very small periods, in the order of 30 nm, we are in the effective medium region, and color effects are affected by changes in the effective refractive index of the surface film controlled by filling fraction FF and period P1 and P2. As the period is increased, first order emerges in the transmission around 100 nm, and the highly complex reflection patterns must now be described in the context of the resonance regime. The period is increased even further to around 380 nm, and we reach the border between the resonance regime and the diffraction regime, where first order emerges in the reflection, and specular colors become less significant and “clean”. It is found that only specific values of height h, filling factor FF, and period create distinct color effects. For larger incident angles, only small periods produce angle-independent colors, see FIG. 7 b).

FIG. 7B shows the same information as FIG. 7A but with RGB values where each parameter field in the graph has a red, green, and blue column indicating the corresponding RGB value. The silicon wafer is not shown here. In conclusion, the structural color appearance of silicon diffraction gratings was examined based on four diffraction gratings with periods of 500 nm, 400 nm, 300 nm, and 200 nm. The reflection and daylight-colors were measured and compared to simulations based on RCWA and CIE color theory. The method was used to predict the structural color appearance of silicon gratings for a wide range of design parameters. Finally, it was shown that non-diffractive angle-independent colors up to 70 deg. of incidence may be provided by deliberately suppressing diffraction and by coupling to normal incidence absorption anomalies.

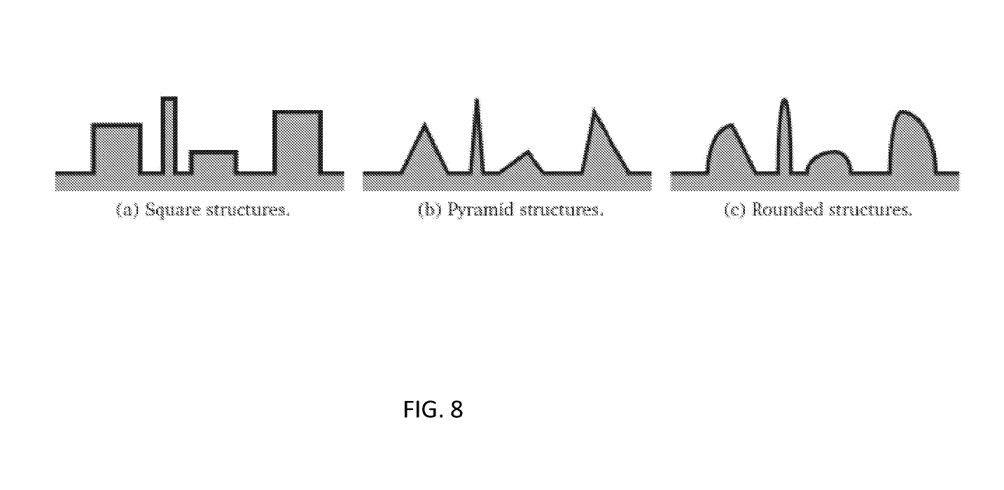

FIGS. 8-10 illustrate an embodiment of an optical device according to the present invention manufactured in polymer. The limitations imposed by the injection moulding production platform itself must be considered. Injection-moulding requires that the parts are able to be separated from the master (insert) without damage after processing. Therefore all surface structures examined have a shape that allows for this separation, such as the pyramid shape. Any topography may only consist of one layer of alteration without closed air-filled regions inside the material. One may refer to these uni-material structures of one layer, that have zero or positively sloped sidewalls, as injection-moulding compatible structures, because they in general allow for the separation of the master and the product in an injection-moulding machine. Examples are given in FIG. 8, where injection-moulding compatible structures are defined with respect to an initial flat micro-scale surface. Any structure may only consist of one layer of alteration on top of bulk. No closed air-filled regions inside the material are allowed. All individual structures or combinations may be periodic or semi-periodic. In general, the present invention relates to structures of the square-like type because the reflection possible is maximum in that configuration as will be explained below.

The topography limitations described above generally indicates that the advanced multi-layer structures often found in nature, on butterfly scales and similar, cannot be fabricated using a one-step injection molding process.

The topography limitations described above have consequences for the optical performance of a given surface. It has been shown experimentally and verified in recent un-published work, that the upper limit of surface reflection for all injection-molding compatible structures are given by the reflection of a plane dielectric interface, where the largest difference in refractive index occurs and thus the largest reflection of energy. The reflection of plane dielectric interface is also known as Fresnel or specular reflection, often arising from mirror like surfaces. This limitation applies for all values of the bulk refractive index larger than that of the surrounding medium (air).

Specular reflection for normal incidence is independent of polarization and can be calculated to be:

$${R}_{⊥} = {( \frac{{n}_{1} - {n}_{2}}{{n}_{1} + {n}_{2}} )}^{2} = {( \frac{1.0 - 1.5}{1.0 + 1.5} )}^{2} = \underline{\underline{0.04}} ,$$

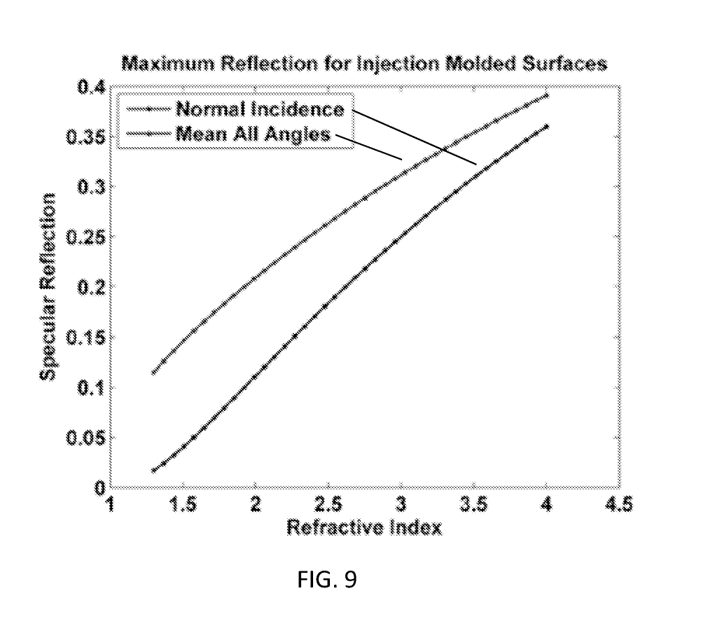

indicating that plastic materials with a refractive index of 1.5 only reflect 4% of the incoming normal light. This is an important figure. If a design in clear plastic is used, we may only alter 4% of the light normal to the surface. The remaining 96% is transmitted into bulk. It is seen that, as the numerical difference between the two refractive indices becomes smaller, the reflection is reduced. In FIG. 9, the specular reflection is seen as function of refractive index for normal incidence and averaged over all incoming angles (hemispherical reflection).

### Fabrication of Nano-Structured Polymer Surfaces Using Dry Etching, Electroplating and Injection Molding

The fabrication scheme consists of a pattern definition by Electron Beam Lithography, deep reactive ion etching in a silicon substrate, electroplating in nickel and injection molding in various polymers. This provides a versatile standardized prototyping technology directly applicable to mass production. The relatively expensive step requiring nanofabrication is only performed once on a single master and identical polymer devices can be produced in high quantity. First, a pattern is transferred to a thin layer of polymer, known as a resist, on to a silicon disc, known as a wafer, by Electron Beam Lithography. The positive resist ZEP 520A is spin-coated on top of a wafer with a thickness of around 160 nm, measured in detail by ellipsometry. Then the wafer is exposed using the JEOL JBX-9500FS spot electron beam type lithography system with different doses in the order of 100 uC/cm². The electrons in the beam have energies of 100 keV. After the exposure, the positive resist is developed, which removes the resist where holes are to be defined.

Dry etching with the resist as an etch mask is used to transfer the pattern into silicon. Here the STS Pegasus Silicon Etching Tool is used, a machine etching both accurately and homogenously in silicon wafers by Advanced Reactive Ion Etching (RIE). The optimized recipe uses a gas mixture of C₄F₈ and SF₆. The etch causes holes to be defined in the silicon, thereby creating a two layer horizontal topography with vertical sidewalls.

Finally, the remaining resist is removed by using microwaves and oxygen plasma. Hereafter the silicon wafer may be used as a master to imprint directly into a plastic disc.

However, a nickel electroform, known as a shim, can also be produced from the nanofabricated silicon master. Nickel is hard and suitable for making injection molding tool inserts. Here the Technotrans microform nickel electroplating machine at DTU Danchip may be used. The electrochemical deposition of nickel takes place at the cathode (the Si surface), where nickel ions from solution are reduced to metallic nickel. The plating bath used is an aqueous solution of nickel sulphamate, boric acid and sulfamic acid, which is moderately acidic (pH=3.5-3.8). As the surface of the Si wafer must be a good conductor of electricity for the process to work, it is necessary to cover the wafer with a seed metal. A standard seed layer of the DVD industry is 50 nm of NiV. The final Ni shim is then cut to the right dimensions.

The Ni shim is now ready to be used for injection molding. Here the Engel Victory 80/45 Tech hydraulic injection molding machine at DTU Danchip may be used. The key process capabilities are 450 kN (45 tonnes) maximum clamp force and about 150° C. maximum tool temperature. The machine can be used for variotherm processes. Various plastics are injected into a mold containing the nickel master, upon solidification the plastic component is released from the tool. Thereby nano-structured polymer surfaces can be produced in high quantity.

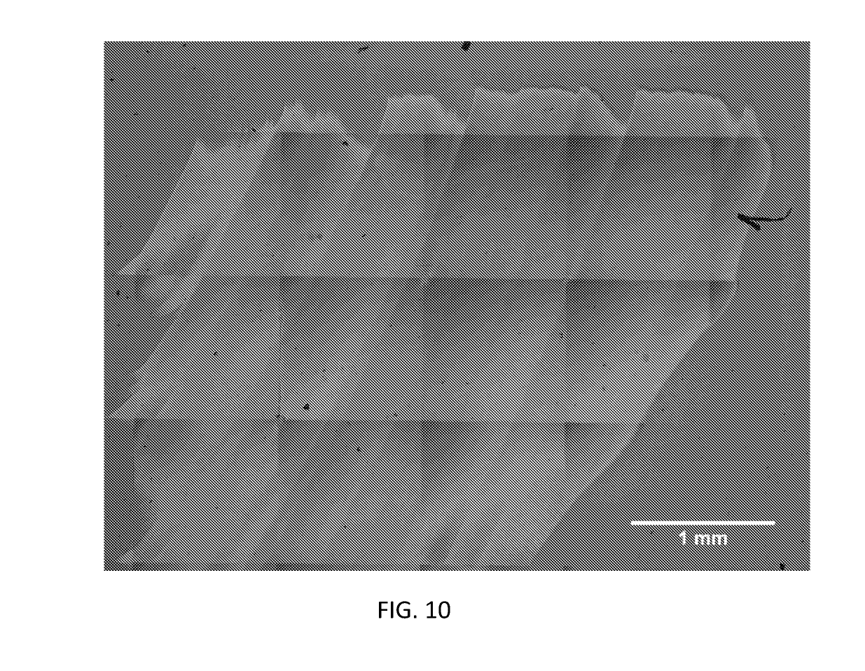

FIG. 10 is an example of an optical device according to the invention manufactured in a polymer, PMMA, resulting in an overall blue of the optical device made by a demonstrator experiment using a silicon wafer as the master. Such techniques could be highly useful for decorative purposes.

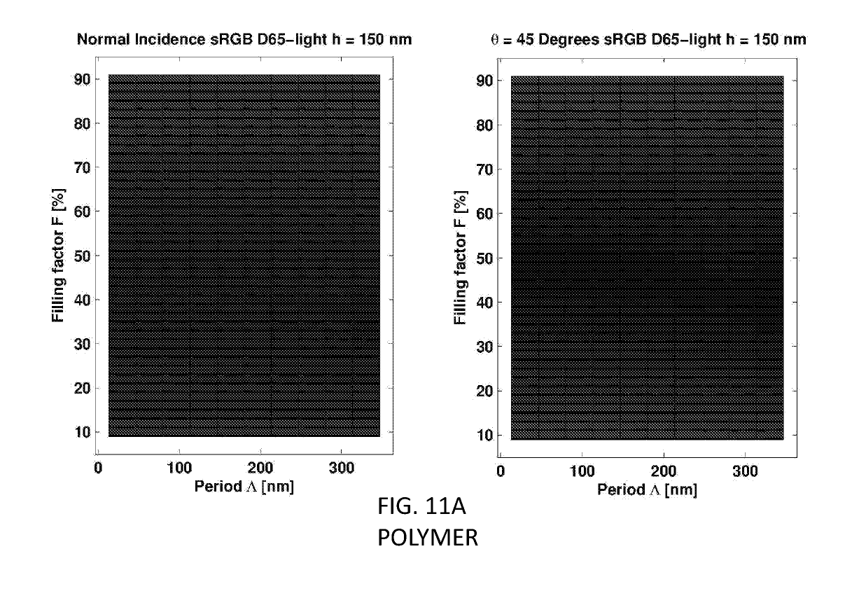

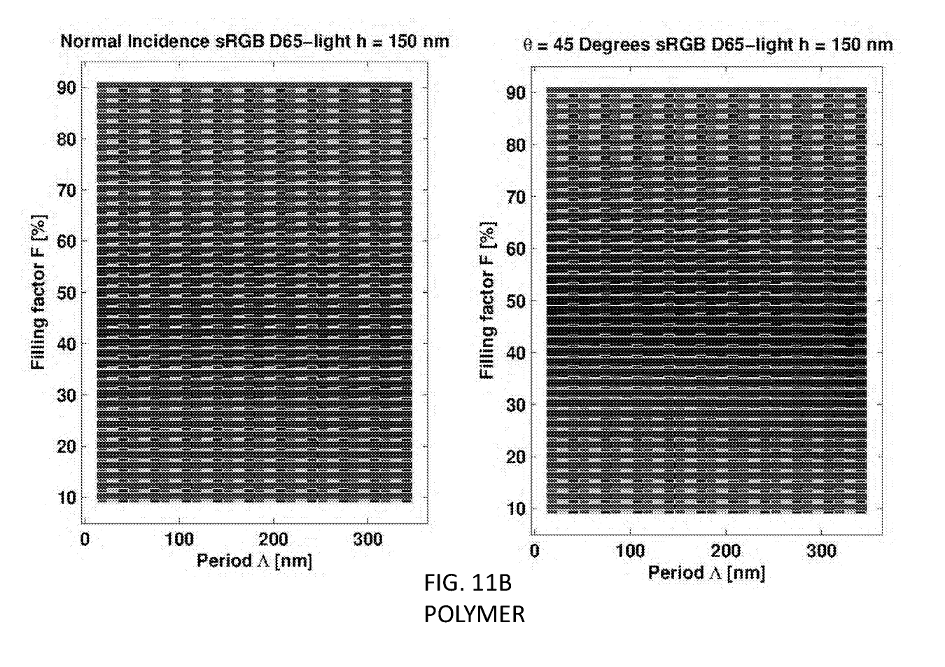

FIGS. 11-13 are a stimulated specular reflection color maps performed for an optical device according to the present invention manufactured in polymer, a material with a refractive index, n, of 2, and metal (aluminium). The reflection and daylight-colors were made by simulations based on RCWA and CIE color theory as explained above for silicon.

FIG. 11A shows normal incidence to the left and A_in, or θᵢₙ, equal to 45 deg. to the right, both for a height, h, of 150 nm. It is seen that the angle independence is good for a given period and filling factor.

FIG. 11B shows the same information as FIG. 11A but with RGB values where each parameter field in the graph has a red, green, and blue column indicating the corresponding RGB value.

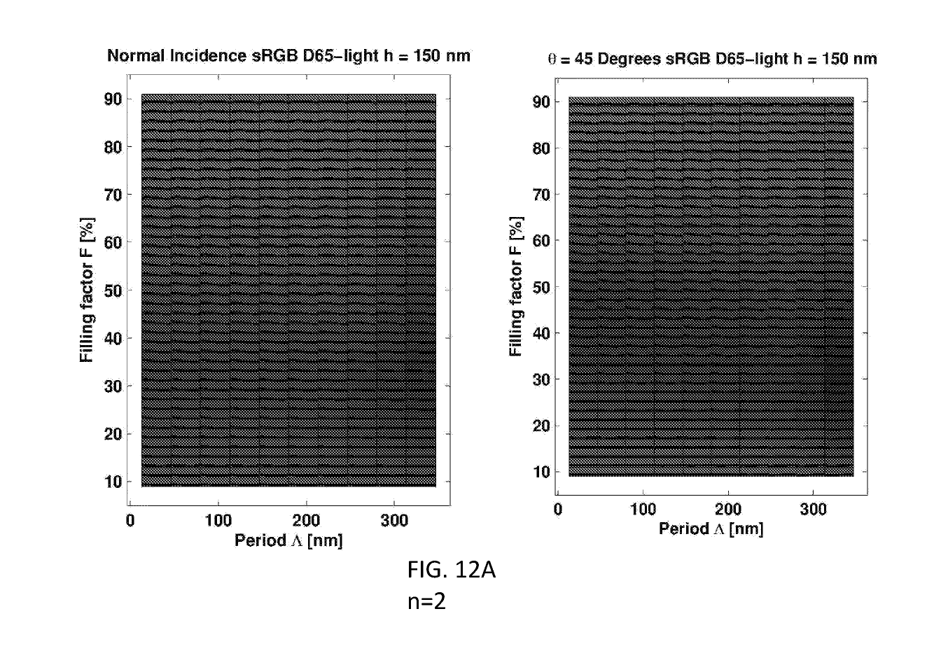

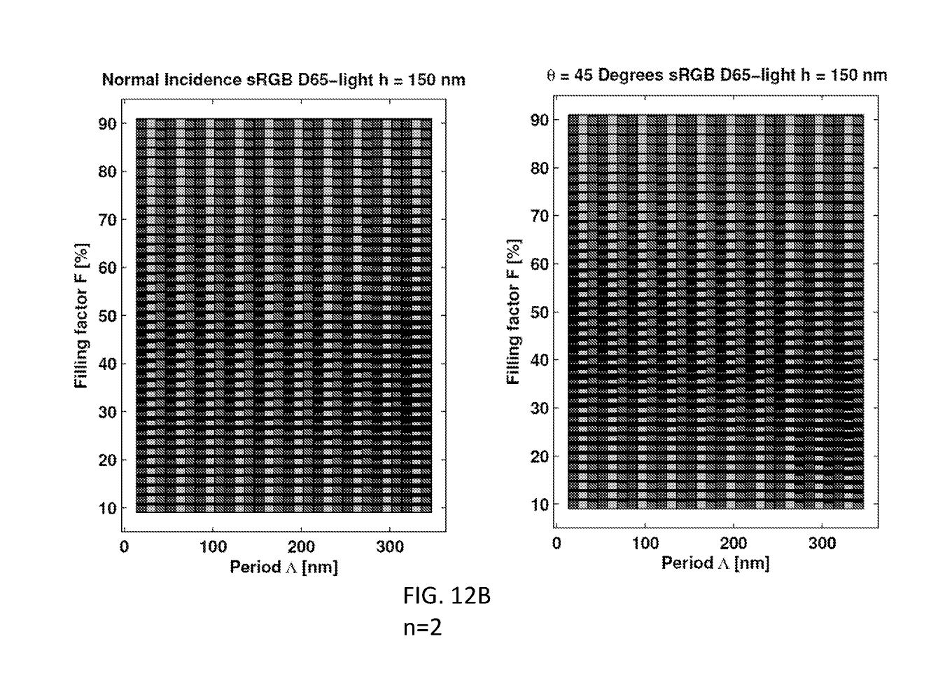

FIG. 12A shows a specular color map for n=2 i.e. a high refractive polymer or a glass. Again, normal incidence is shown to the left with A_in, or θᵢₙ, equal to 45 deg. to the right, both for a height, h, of 150 nm. The angle independence or insensitivity is again documented.

FIG. 12B shows the same information as FIG. 12A but with RGB values where each parameter field in the graph has a red, green, and blue column indicating the corresponding RGB value.

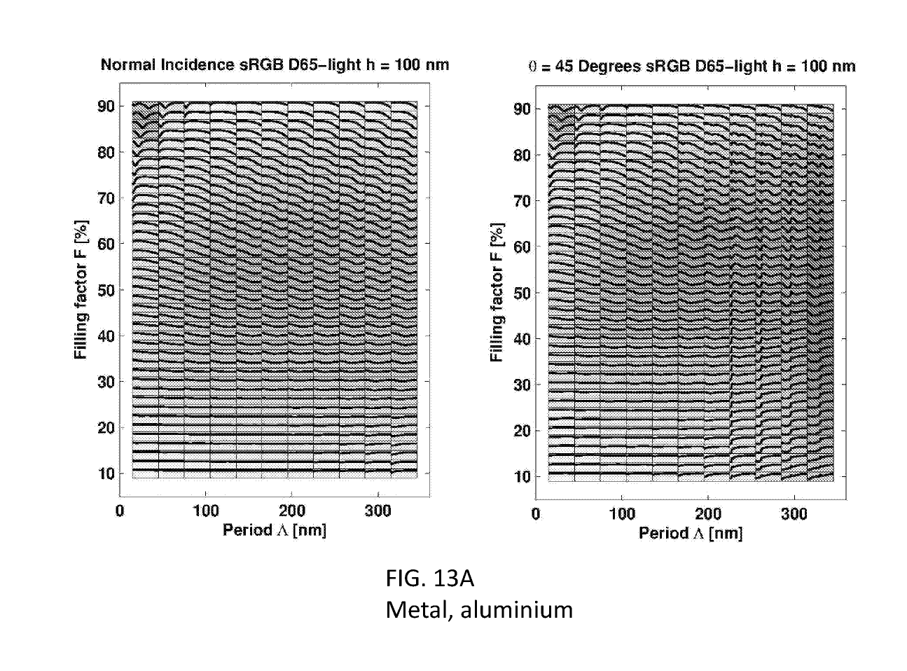

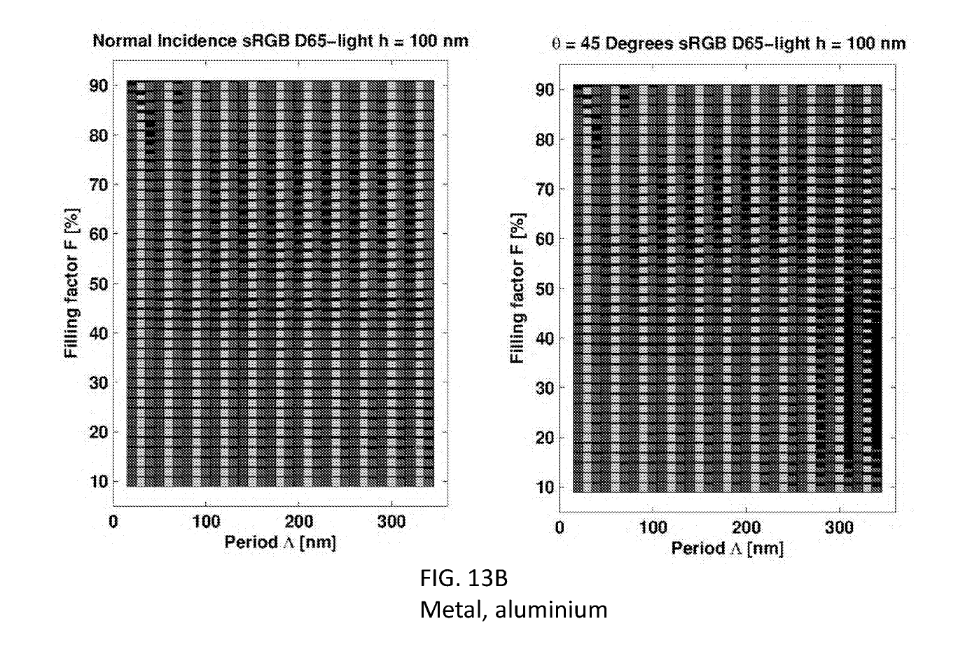

FIG. 13A shows normal incidence to the left and A_in, or θᵢₙ, equal to 45 deg. to the right, both for a height, h, of 100 nm. It is seen that the angle independence is good for a given period and filling factor, though periodicity below approximately 250 nm may be best for aluminium.

FIG. 13B shows the same information as FIG. 13A but with RGB values where each parameter field in the graph has a red, green, and blue column indicating the corresponding RGB value.

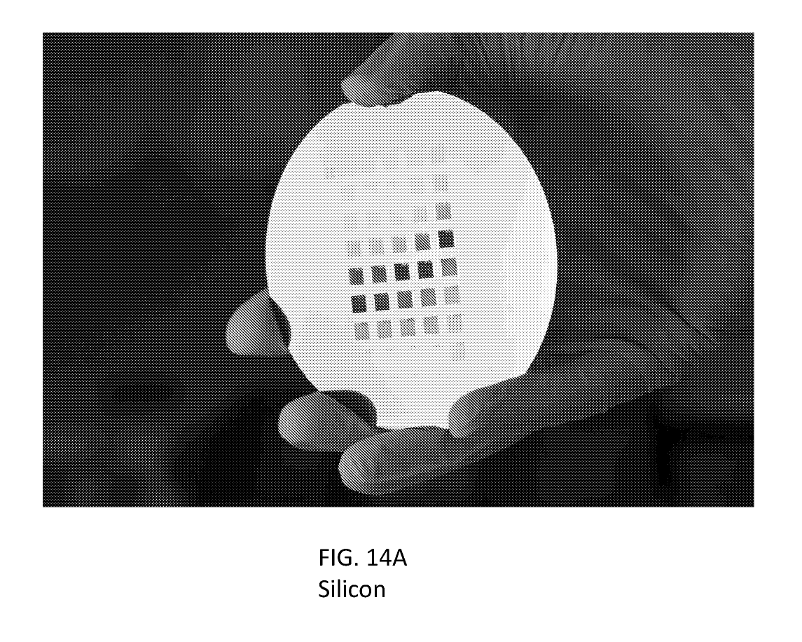

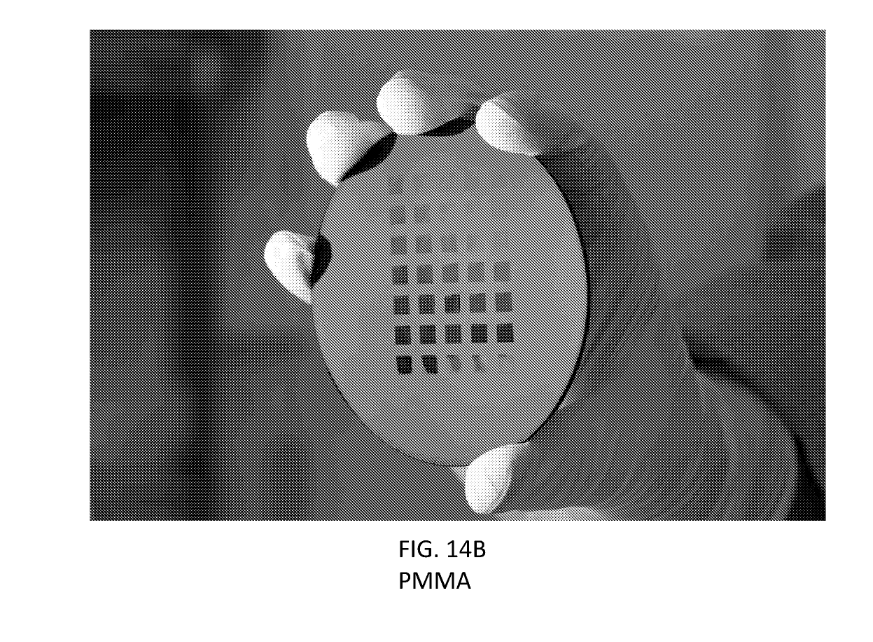

FIG. 14A is a photograph of an optical device according to the invention made in a silicon wafer showing visible structural colors resembling a color or shade chart.

FIG. 14B is a photograph of an optical device according to the invention made in polymer, particularly PMMA, made by applying the silicon wafer shown in FIG. 14A as a master to imprint directly into a plastic disc of PMMA. It is noticed how the structural color change when going from silicon to the corresponding nano-structure in polymer because of change in refractive index.

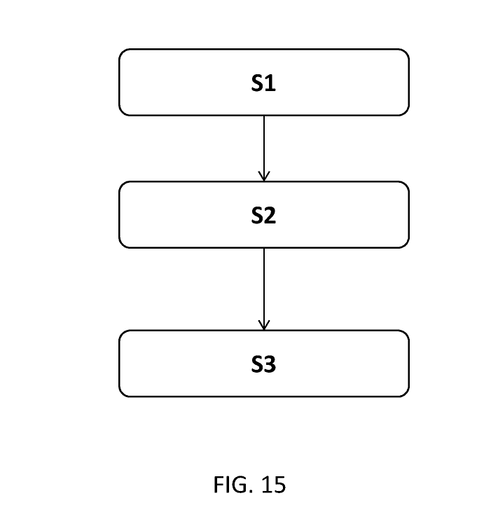

FIG. 15 is a schematic flow chart representing an out-line of the method for manufacturing an optical device having a nano-structured surface capable of providing a structural color to the normal human eye, the method comprising:
S1 providing a form comprising a corresponding master structure for the nano-structured surface capable of providing a structural color to the normal human eye,
S2 performing a molding, casting or forming process with the form using a moldable material, and
S3 obtaining the optical device, the device made being manufactured in said moldable material, the device comprising:
a bulk portion of device,
a surface portion of the device; both the bulk portion and the surface portion being manufactured in one and the same moldable material, and
a plurality of nano-structured protrusions being part of the surface portion of the device, the nano-structured protrusions having an average height level h above an interface between the surface portion and the bulk portion, the nano-structured protrusions having substantially vertical sidewalls with respect to the said interface between the surface portion and the bulk portion, the nano-structured protrusions defining a filling factor FF being the ratio of the area of nano-structured protrusions relative to the total surface area,
   wherein the plurality of nano-structured protrusions is further arranged with a first periodicity P1 in a first direction and a second periodicity P2 in a second direction, the first and second periodicity being chosen so that the optical reflection is dominated by specular reflection at least up to a maximum angle of incidence with respect to a normal to the surface, both the first and the second periodicity, P1 and P2, being below approximately 300 nm, preferably 250 nm, and larger than 100 nm, preferably 150 nm,
   wherein the plurality of nano-structured protrusions is optionally arranged with a relative spatial randomness SR with respect to the average surface positions, the spatial randomness varying both with respect to the distance d and direction A, or θ, of an average surface position of a protrusion, cf. FIG. 3A, and
   wherein the height level h of the protrusions, the first and second periodicity, P1 and P2, of the protrusions, optionally the relative spatial randomness SR of the protrusions, and the filling factor FF of the protrusions are chosen so as to provide, at least up to said maximum angle of incidence A_in with respect to a normal to the surface, an angle-independent substantially homogeneous structural color perception for a normal human viewer, at least up to a maximum observation angle A_obs with respect to a normal to the surface.

In short, the present invention relates to an optical device having a nano-structured surface capable of providing a structural color to a normal human viewer, the device made being manufactured in one single material. A wherein the plurality of nano-structured protrusions 5 is further arranged with a first periodicity P1 in a first direction and a second periodicity P2 in a second direction, the first and second periodicity being chosen so that the optical reflection is dominated by specular reflection. The nano-structured protrusions are optionally arranged with a relative spatial randomness (SR) with respect to the average surface positions. The position, size, and randomness of the protrusions are arranged so as to provide, at least up to a maximum angle of incidence (A_in) with respect to a normal to the surface, an angle-independent substantially homogeneous structural color perception for a normal human viewer, at least up to a maximum observation angle (A_obs) with respect to a normal to the surface.

The invention can be implemented by means of hardware, software, firmware or any combination of these. The invention or some of the features thereof can also be implemented as software running on one or more data processors and/or digital signal processors.

The individual elements of an embodiment of the invention may be physically, functionally and logically implemented in any suitable way such as in a single unit, in a plurality of units or as part of separate functional units. The invention may be implemented in a single unit, or be both physically and functionally distributed between different units and processors.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

### Annex:

Below is a number of aspects and embodiments corresponding to the claims of the priority founding application EP 13170492 to the same applicants.

1. An optical device (10) having a nano-structured surface capable of providing a structural color to a normal human viewer, the device made being manufacturing in one material, the device comprising:
a bulk portion (3) of device,
a surface portion (4) of the device; both the bulk portion and the surface portion being manufactured in one and the same material, and
a plurality of nano-structured protrusions (5) being part of the surface portion of the device, the nano-structured protrusions having an average height level (h) above an interface between the surface portion and the bulk portion, the nano-structured protrusions having substantially vertical sidewalls with respect to the said interface between the surface portion and the bulk portion, the nano-structured protrusions defining a filling factor (FF) being the ratio of the area of nano-structured protrusions relative to the total surface area,
   wherein the plurality of nano-structured protrusions is further arranged with a first periodicity (P1) in a first direction and a second periodicity (P2) in a second direction, the first and second periodicity being chosen so that the optical reflection is dominated by specular reflection at least up to a maximum angle of incidence with respect to a normal to the surface, both the first and the second periodicity (P1, P2) being below approximately 300 nm, preferably 250 nm, and larger than 100 nm, preferably 150 nm,
   wherein the plurality of nano-structured protrusions is additionally arranged with a relative spatial randomness (SR) with respect to the average surface positions, the spatial randomness varying both with respect to the distance (d) and the direction (A) of an average surface position of a protrusion, and
   wherein the height level (h) of the protrusions, the first and second periodicity (P1, P2) of the protrusions, the relative spatial randomness (SR) of the protrusions, and the filling factor (FF) of the protrusions are chosen so as to provide, at least up to said maximum angle of incidence (A_in) with respect to a normal to the surface, an angle-independent substantially homogeneous structural color perception for a normal human viewer, at least up to a maximum observation angle (A_obs) with respect to a normal to the surface.
   2. The optical device according to embodiment 1, wherein the specular reflection is a substantially mirror-like reflection in which an incident light beam is primarily reflected into a single observational angle (A_obs) for all azimuthal angles.
   3. The optical device according to embodiment 1 or 2, wherein the optical device has resulting optical properties causing the specular reflection, which can be described in an effective medium optical regime where thin film reflection dominates together with an resonance regime.
   4. The optical device according to embodiment 1, 2 or 3, wherein the optical device functions as a non-diffractive grating for which the first and second periodicity is sufficiently small to ensure that zeroth order diffraction, m=0, is the dominant reflection.
   5. The optical device according to embodiment 4, wherein the optical device fulfils the inequality;

$$\frac{Λ}{λ} < \frac{1}{max ( {n}_{2} , {n}_{1} ) + {n}_{1} sin {θ}_{max}} ,$$

where Λ is the first (P1) and second (P2) periodicity of the first and the second, Λ is the wavelength of the incident light in the visible range, n2 is the refractive index of the material the optical device is made of, and n1 is the refractive index of the surrounding medium, such as atmospheric air having n1 approximately equal to 1.
6. The optical device according to any of embodiments 1-5, wherein the optical device has an angle-independent specular reflection for a maximum observation angle (A_obs) with respect to a normal to the surface for at least 45 degrees, preferably at least 60 degrees, more preferably at least 75 degrees for an angle of incident angle (A_in) of zero with respect to a normal to the surface.
7. The optical device according to any of embodiments 1-6, wherein the substantially vertical sidewalls with respect to the normal of said interface between the surface portion and the bulk portion have a slope angle of maximum 2 degrees, preferably maximum 5 degrees, more preferably maximum 10 degrees.
8. The optical device according to any of embodiments 1-7, wherein the nano-structured protrusions having an average height level (h) above an interface between the surface portion and the bulk portion in the interval from approximately 30-300 nm, preferably approximately 40-250 nm, more preferably approximately
50-200 nm.
9. The optical device according to any of embodiments 1-8, wherein the nano-structured protrusions have a spatial randomness (SR) with respect to the average surface positions, the spatial randomness varying both with respect to the distance (d) and direction (A) of an average surface position of a protrusion, of at least 5%, preferably at least 10%, more preferably at least 15%.
10. The optical device according to any of embodiments 1-5, wherein the said material is a semiconductor material, such as silicium, preferably the shape of the protrusions, as seen normal to the said interface, being of a quadratic, a pentagonal, a hexagonal, or higher order polygonal form.
11. The optical device according to any of embodiments 1-5, wherein the said material is a dielectric material, such as a polymer, preferably the filling factor (FF) being in the interval from 35-65%.
12. The optical device according to any of embodiments 1-5, wherein the said material is a metal or metal alloy.
13. A method for manufacturing an optical device having a nano-structured surface capable of providing a structural color to the normal human eye, the method comprising:
providing a form comprising a corresponding master structure for the nano-structured surface capable of providing a structural color to the normal human eye,
performing a molding, casting or forming process with the form using a moldable material, and
obtaining the optical device, the device made being manufacturing in said moldable material, the device comprising:
a bulk portion of device,
a surface portion of the device; both the bulk portion and the surface portion being manufactured in one and the same moldable material, and
a plurality of nano-structured protrusions being part of the surface portion of the device, the nano-structured protrusions having an average height level (h) above an interface between the surface portion and the bulk portion, the nano-structured protrusions having substantially vertical sidewalls with respect to the said interface between the surface portion and the bulk portion, the nano-structured protrusions defining a filling factor (FF) being the ratio of the area of nano-structured protrusions relative to the total surface area,
   wherein the plurality of nano-structured protrusions is further arranged with a first periodicity (P1) in a first direction and a second periodicity (P2) in a second direction, the first and second periodicity being chosen so that the optical reflection is dominated by specular reflection at least up to a maximum angle of incidence with respect to a normal to the surface, both the first and the second periodicity (P1, P2) being below approximately 300 nm, preferably 250 nm, and larger than 100 nm, preferably 150 nm,
   wherein the plurality of nano-structured protrusions is additionally arranged with a relative spatial randomness (SR) with respect to the average surface positions, the spatial randomness varying both with respect to the distance (d) and the direction (A) of an average surface position of a protrusion, and
   wherein the height level (h) of the protrusions, the first and second periodicity (P1, P2) of the protrusions, the relative spatial randomness (SR) of the protrusions, and the filling factor (FF) of the protrusions are chosen so as to provide, at least up to said maximum angle of incidence (A_in) with respect to a normal to the surface, an angle-independent substantially homogeneous structural color perception for a normal human viewer, at least up to a maximum observation angle (A_obs) with respect to a normal to the surface.
   14. The method according to embodiment 13, wherein the form is an injection molding tool capable of performing injection molding.
   15. The method according to embodiment 13 or 14, wherein the performing of a molding, casting or forming process is an injection molding process, and the moldable material comprises a thermoplastic.
   16. The method according to any of embodiments 13-15, wherein the nano-structured protrusions have an average Aspect ratio being at least approximately 1:2, preferably at least approximately 1:1, more preferably at least approximately 2:1.

1. An optical device (10) having a nano-structured surface capable of providing a structural color to a normal human viewer, the device made being manufactured in one material, the device comprising:
a bulk portion (3) of device,
a surface portion (4) of the device; both the bulk portion and the surface portion being manufactured in one and the same material, and
a plurality of nano-structured protrusions (5) being part of the surface portion of the device, the nano-structured protrusions having an average height level (h) above an interface between the surface portion and the bulk portion, the nano-structured protrusions having substantially vertical sidewalls with respect to the said interface between the surface portion and the bulk portion, the nano-structured protrusions defining a filling factor (FF) being the ratio of the area of nano-structured protrusions relative to the total surface area,
wherein the plurality of nano-structured protrusions is further arranged with a first periodicity (P1) in a first direction and a second periodicity (P2) in a second direction, the first and second periodicity being chosen so that the optical reflection is dominated by specular reflection at least up to a maximum angle of incidence with respect to a normal to the surface, both the first and the second periodicity (P1, P2) being below approximately 300 nm, preferably 250 nm, and larger than 100 nm, preferably 150 nm, and
wherein the height level (h) of the protrusions, the first and second periodicity (P1, P2) of the protrusions, and the filling factor (FF) of the protrusions are chosen so as to provide, at least up to said maximum angle of incidence (A_in) with respect to a normal to the surface, an angle-independent substantially homogeneous structural color perception for a normal human viewer, at least up to a maximum observation angle (A_obs) with respect to a normal to the surface.

2. The optical device according to claim 1, wherein the specular reflection is a substantially mirror-like reflection in which an incident light beam is primarily reflected into a single observational angle (A_obs) for all azimuthal angles.

3. The optical device according to claim 1 or 2, wherein the optical device has resulting optical properties causing the specular reflection, which can be described in an effective medium optical regime where thin film reflection dominates together with an resonance regime.

4. The optical device according to claim 1, 2 or 3, wherein the optical device functions as a non-diffractive grating for which the first and second periodicity is sufficiently small to ensure that zeroth order diffraction, m=0, is the dominant reflection.

5. The optical device according to claim 4, wherein the optical device fulfils the inequality;
$$\frac{Λ}{λ} < \frac{1}{max ( {n}_{2} , {n}_{1} ) + {n}_{1} sin {θ}_{max}} ,$$
where Λ is the first (P1) and second (P2) periodicity of the first and the second directions, respectively, λ is the wavelength of the incident light in the visible range, n2 is the refractive index of the material the optical device is made of, and n1 is the refractive index of the surrounding medium, such as atmospheric air having n1 approximately equal to 1.

6. The optical device according to any of claims 1-5, wherein the optical device has an angle-independent specular reflection for a maximum observation angle (A_obs) with respect to a normal to the surface for at least 45 degrees, preferably at least 60 degrees, more preferably at least 75 degrees for an angle of incident angle (A_in) of zero with respect to a normal to the surface.

7. The optical device according to any of claims 1-6, wherein the substantially vertical sidewalls with respect to the normal of said interface between the surface portion and the bulk portion have a slope angle of maximum 2 degrees, preferably maximum 5 degrees, more preferably maximum 10 degrees.

8. The optical device according to any of claims 1-7, wherein the nano-structured protrusions having an average height level (h) above an interface between the surface portion and the bulk portion in the interval from approximately 30-300 nm, preferably approximately 40-250 nm, more preferably approximately
50-200 nm.

9. The optical device according to any of claims 1-8, wherein the plurality of nano-structured protrusions is additionally arranged with a relative spatial randomness (SR) with respect to the average surface positions, the spatial randomness varying both with respect to the distance (d) and the direction (A) of an average surface position of a protrusion, and wherein the relative spatial randomness (SR) of the protrusions is chosen so as to provide, at least up to said maximum angle of incidence (A_in) with respect to a normal to the surface, an angle-independent substantially homogeneous structural color perception for a normal human viewer, at least up to a maximum observation angle (A_obs) with respect to a normal to the surface.

10. The optical device according to claim 9, wherein the nano-structured protrusions have a spatial randomness (SR) with respect to the average surface positions, the spatial randomness varying both with respect to the distance (d) and direction (A) of an average surface position of a protrusion, of at least 5%, preferably at least 10%, more preferably at least 15%.

11. The optical device according to any of claims 1-5, wherein the said material is a semiconductor material, such as silicon, preferably the shape of the protrusions, as seen normal to the said interface, being of a quadratic, a pentagonal, a hexagonal, or higher order polygonal form.

12. The optical device according to any of claims 1-5, wherein the said material is a dielectric material, such as a polymer, preferably the filling factor (FF) being in the interval from 35-65%.

13. The optical device according to any of claims 1-5, wherein the said material is a metal or metal alloy.

14. A method for manufacturing an optical device having a nano-structured surface capable of providing a structural color to the normal human eye, the method comprising:
providing a form comprising a corresponding master structure for the nano-structured surface capable of providing a structural color to the normal human eye,
performing a molding, casting or forming process with the form using a moldable material, and
obtaining the optical device, the device made being manufactured in said moldable material, the device comprising:
a bulk portion of device,
a surface portion of the device; both the bulk portion and the surface portion being manufactured in one and the same moldable material, and
a plurality of nano-structured protrusions being part of the surface portion of the device, the nano-structured protrusions having an average height level (h) above an interface between the surface portion and the bulk portion, the nano-structured protrusions having substantially vertical sidewalls with respect to the said interface between the surface portion and the bulk portion, the nano-structured protrusions defining a filling factor (FF) being the ratio of the area of nano-structured protrusions relative to the total surface area,
wherein the plurality of nano-structured protrusions is further arranged with a first periodicity (P1) in a first direction and a second periodicity (P2) in a second direction, the first and second periodicity being chosen so that the optical reflection is dominated by specular reflection at least up to a maximum angle of incidence with respect to a normal to the surface, both the first and the second periodicity (P1, P2) being below approximately 300 nm, preferably 250 nm, and larger than 100 nm, preferably 150 nm, and
wherein the height level (h) of the protrusions, the first and second periodicity (P1, P2) of the protrusions and the filling factor (FF) of the protrusions are chosen so as to provide, at least up to said maximum angle of incidence (A_in) with respect to a normal to the surface, an angle-independent substantially homogeneous structural color perception for a normal human viewer, at least up to a maximum observation angle (A_obs) with respect to a normal to the surface.

15. The method according to claim 14, wherein the form is an injection molding tool capable of performing injection molding.

16. The method according to claim 14 or 15, wherein the performing of a molding, casting or forming process is an injection molding process, and the moldable material comprises a thermoplastic.

17. The method according to any of claims 14-16d, wherein the nano-structured protrusions have an average Aspect ratio being at least approximately 1:2, preferably at least approximately 1:1, more preferably at least approximately 2:1.
